(19) United States
(12) Patent Application Publication
(10) Pub. No.: US 2025/0110361 A1
(43) Pub. Date: Apr. 3, 2025

(54) SLOW-LIGHT PHOTONIC MODULATORS FOR RADIO-FREQUENCY PHOTONIC SYSTEM

(71) Applicant: RENSSELAER POLYTECHNIC INSTITUTE, Troy, NY (US)

(72) Inventors: Zhaoran Huang, Clifton Park, NY (US); Stephen Anderson, Yorktown Heights, NY (US); Amir Begovic, Troy, NY (US)

(73) Assignee: RENSSELAER POLYTECHNIC INSTITUTE, Troy, NY (US)

(21) Appl. No.: 18/725,208

(22) PCT Filed: Nov. 7, 2022
(86) PCT No.: PCT/US2022/049098

§ 371 Date: Jun. 28, 2024

Related U.S. Application Data
(60) Provisional application No. 63/297,285, filed on Jan. 7, 2022.

(51) Int. Cl. G02F 1/025

(52) U.S. Cl. CPC G02F 1/025

(57) ABSTRACT

A slow-light photonic modulator includes a silicon-on-insulator substrate that includes a silicon device layer on top of a silicon dioxide buried layer. A ridge waveguide is formed partially etching the silicon device layer. The ridge waveguide includes a grating arm and a reference arm. A grating waveguide and a grating electrode are in the grating arm. A straight waveguide and a reference electrode are in the reference arm. A lateral junction is formed by doping the ridge waveguide with p-type and n-type dopants. In some embodiments, the slow-light photonic modulator further includes an unequal phase shifter architecture that is configured to set the modulator in quadrature without the use of external waveguide heaters.

### CROSS REFERENCE TO RELATED APPLICATION(S)

This application claims the priority benefit of U.S. Provisional Patent Application No. 63/297,285, filed Jan. 7, 2022, which is incorporated by reference as if disclosed herein in its entirety.

### STATEMENT REGARDING FEDERALLY SPONSORED RESEARCH AND DEVELOPMENT

The present invention was made with government support under Grant No. W911NF-19-2-0170 awarded by the United States Department of Defense Army Research Laboratory Cooperative Agreement. The government has certain rights in the invention.

### FIELD

The present technology relates generally to the field of optical modulation, and more particularly, to slow-light silicon Mach-Zehnder modulators for radio-frequency photonic systems, and methods of forming thereof.

### BACKGROUND

The photonic modulator is a critical component in a myriad of radio-frequency (RF) photonic systems, serving to transduce RF signals into the optical domain. LiNbO₃ modulators represent the current industry preference, as they have low insertion loss and allow for RF links to operate at high speed while maintaining a large link spur-free dynamic range (SFDR). An integrated chip-scale RF photonic link offers significant size, weight, power, and cost (SWaP-C) advantages and is in high demand for many applications. In recent years, efforts to heterogeneously integrate thin-film LiNbO₃ onto a silicon (Si) platform have demonstrated some promise but have not been widely adopted by silicon photonics foundries due to the relative difficulty in processing. The Si optical modulator is an attractive alternative technology and has been recently studied for both high-speed optical interconnection applications and analog RF photonic applications.

Recently, Si Mach-Zehnder modulators (MZM) realized with foundry processes have been demonstrated for RF photonic links. However, there are several practical concerns not sufficiently addressed so far. First, many current MZM designs have incorporated silicon heaters in both MZM arms that are addressed separately to unbalance the phase shifter to set the MZM at its quadrature point. The on-chip heaters not only add extra chip surface area but also require stringent thermal isolation. Second, Si MZMs typically have millimeters-long phase shifters, and they require differential-driving or distributed-driving techniques which increases the system complexity.

Additionally, silicon modulators are of particular interest as they do not introduce the need to heterogeneously integrate other materials such as lithium niobate. The footprint of the modulator must be kept as small as possible. To reduce the device length, higher light-matter interaction has been accomplished using photonic crystal waveguides and Bragg-like slow-light waveguides. In each case, the depletion of carriers in the waveguide cross-section interacts with the guided optical mode, producing a stronger phase-change-per-unit-length. However, the impact of using such slow-light devices on the analog performance of the modulators has not been investigated thoroughly. Also, the SFDR of the modulator is reduced due to the loss mismatch between the slow-light optical path and the interferometer's reference path.

What is needed, therefore, are improved slow-light silicon modulators that address at least the problems described above.

### SUMMARY

According to an embodiment of the present technology, a slow-light photonic modulator is provided. The slow-light photonic modulator includes a silicon-on-insulator substrate that includes a silicon device layer on top of a silicon dioxide buried layer. A ridge waveguide is formed partially etching the silicon device layer. The ridge waveguide includes a grating arm and a reference arm. A grating waveguide and a grating electrode are in the grating arm. A straight waveguide and a reference electrode are in the reference arm. A lateral junction is formed by doping the ridge waveguide with p-type and n-type dopants.

In some embodiments, the slow-light photonic modulator further includes a y-splitter that is configured to split an input optical signal into two paths, a first of the two paths passes through the grating arm and a second of the two paths passes through the reference arm; and a y-combiner that is configured to recombine the first and the second of the two paths into an output optical signal after the first and the second of the two paths passes through the respective grating and reference arms.

In some embodiments, the slow-light photonic modulator further includes an unequal phase shifter architecture that is configured to set the modulator in quadrature without the use of external waveguide heaters.

In some embodiments, the unequal phase shifter architecture includes a first electrical signal applied to the grating electrode, the first electrical signal includes a first direct current bias component and a small-signal radio-frequency component; and a second electrical signal applied to the reference electrode, the second electrical signal includes a second direct current bias component.

In some embodiments, the small-signal radio-frequency component includes a first radio-frequency signal and a second radio-frequency signal, each of which passes through respective first and second band-pass filters before being combined with the first direct current bias component.

In some embodiments, the first radio-frequency signal and the second radio-frequency signal are supplied by a dual-channel microwave generator.

In some embodiments, the first direct current bias component includes a direct current bias voltage, and the second direct current bias component includes a variable direct current voltage.

In some embodiments, the first direct current bias component and the second direct current bias component are supplied by a bias-tee.

In some embodiments, the slow-light photonic modulator further includes a silicon-germanium photodetector in optical communication with the ridge waveguide.

In some embodiments, the silicon-germanium photodetector is positioned in the silicon-on-insulator substrate and is in optical communication with the ridge waveguide via an embedded single-mode silicon photonic waveguide.

In some embodiments, the slow-light photonic modulator further includes a first thermo-optic switch in optical communication with an input side of the ridge waveguide, the first thermo-optic switch includes a first heater; and a second thermo-optic switch in optical communication with an output side of the ridge waveguide, the second thermo-optic switch includes a second heater. The first thermo-optic switch and the second thermo-optic switch are configured to adjust a splitting ratio of an input optical signal inputted to the input side of the ridge waveguide and an output optical signal outputted from the output side of the ridge waveguide.

In some embodiments, the slow-light photonic modulator further includes a third heater positioned in-line with the grating arm between the output side of the ridge waveguide and the second thermo-optic switch. The third heater is configured to set the modulator in quadrature.

In some embodiments, the lateral junction includes a P region and an N region, the P region has a doping concentration that is one order of magnitude greater than a doping concentration of the N region such that the lateral junction is a PP-N junction.

In some embodiments, the ridge waveguide has a length of 500 μm or less.

In some embodiments, the ridge waveguide has a length of 150 μm.

According to an embodiment of the present technology, a radio-frequency photonic link is provided. The radio-frequency photonic link includes a slow-light photonic modulator according to any of the preceding embodiments; a tunable laser that is configured to provide an input optical signal to the slow-light photonic modulator; an optical circulator that is positioned between the tunable laser and the slow-light photonic modulator; an erbium-doped fiber amplified that is positioned between the tunable laser and the optical circulator; and a radio-frequency spectrum analyzer that is configured to receive an output optical signal from the slow-light photonic modulator.

In some embodiments, the radio-frequency photonic link further includes an external low-noise amplifier that is positioned between the slow-light photonic modulator and the radio-frequency spectrum analyzer.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1A is a schematic view of a slow-light enhanced modulator (SLM) according to an exemplary embodiment of the present technology.

FIG. 1B is a cross-sectional view of the SLM of FIG. 1A taken along section A-A′.

FIG. 1C is an optical micrograph of the SLM of FIG. 1A. The SLM is connected to an on-ship SiGe PD with a Si nanowire waveguide on the same die.

FIG. 2 is a schematic of the two-tone test experimental setup for the SLM of FIG. 1A.

FIG. 3A is a chart showing the transmission spectrum of the unbalanced SLM of FIG. 1A under 0V applied bias, and the measured group index of the Bragg grating waveguide. The FSR of adjacent peaks is proportional to the slow light effect. The power transmission of the Bragg grating waveguide is proportional to the interference pattern intensity, i.e., following the envelope of the SLM fringes.

FIG. 3B is a chart showing the normalized intensity as a function of applied voltage, V_{G}. For each case, V_{REF}=0 V. The two operating wavelengths are chosen to represent the modulation near and far from the band edge. For each case, the bias corresponding to the maximum transmission is approximately equal. Near to the band edge, the resulting V_{π}=5.095 V (V_{π}·L=1.019 V·cm), whereas far from the band edge a π-phase shift is not achieved until the modulator is driven into the breakdown regime.

FIG. 4 shows an exemplary eye diagram for the SLM of FIG. 1A. The eye diagram test is conducted at a wavelength of 1550 nm, 500 mVpp, −1.75 V DC, and at a speed of 5 Gbps. A PRBS7 signal is used and shown at the top and bottom, while the modulator output is plotted in the middle.

FIG. 5 is a chart showing a representative plot of SFDR when V_{G}=V_{REF}=−3 V, at the slow-light wavelength 1545.15 nm for the SLM of FIG. 1A. The SFDR is defined as the distance between the 1 Hz bandwidth noise floor and the fundamental tone where the IMD3 tone power equals the noise floor. Similarly, the IP3 figure-of-merit is defined by extrapolation to the point where the fundamental and IMD3 tone powers would be equal if no compression occurred at high input tone powers. Dashed lines are constructed lines extrapolating the measured data.

FIGS. 6A-6D are charts showing photocurrent and SFDR as a function of grating arm bias V_{G} and reference arm bias V_{REF} at selected wavelengths.

FIG. 7 is a chart showing SLM slope efficiency enhancement percentage versus wavelength in the slow-light region. Each datum is measured at a SLM quadrature point with V_{G}=V_{REF}=−3 V. The dashed line is a fitting curve that serves as a guide to the eye.

FIG. 8A is a schematic view of an extinction-ratio-optimized slow-light grating modulator (SLM) according to an exemplary embodiment of the present technology.

FIG. 8B is a cross-sectional view of the SLM of FIG. 8A taken along section B-B′.

FIG. 8C is an optical micrograph of the SLM of FIG. 8A.

FIG. 9 is a chart showing the input thermo-optic switch (TOS) voltage-controlled reconfigurability of the architecture of the SLM of FIG. 8A. The transmission through the SLM can output the grating transfer function alone (0V), an MZI transfer function (2.0V), the ER optimized MZI transfer function (2.5V), and the channel waveguide all-pass device (3.75V).

FIG. 10 is a chart showing the optimized extinction ratio (ER) for an MZM with a grating with excess loss compared to a standard rib waveguide in one arm. The TOS relative phase is the amount of thermally induced phase shift applied to the input TOS. In every case, the output TOS is kept at a constant phase of π/2, acting as an ideal 50/50 re-combiner.

FIG. 11 is a chart showing a simulated optimal ER for a slow-light MZM versus the input TOS phase and the operating wavelength near the grating band edge.

FIG. 12 is a chart showing the splitting ratio versus applied TOS bias (V) for a single TOS.

FIG. 13 is a chart showing the static ER for SLMs according to exemplary embodiments of the present technology across different wavelengths. Results are based around −5 Vdc on both arms for each SLM. The static differential signals were applied to the grating arms.

FIG. 14 is a chart showing an eye diagram operating at 10 Gbps for the SLM of FIG. 8A.

FIG. 15 is a chart showing the SFDR optimization using input TOS control. The maximum SFDR does not correspond to the same splitting ratio as required to obtain the highest fundamental tone transmission.

### DETAILED DESCRIPTION

Accordingly, exemplary embodiments of the present technology are directed to a Si MZM that utilizes Bragg grating based slow-light MZM (SLM). In some embodiments, the SLM has enhanced field-matter interaction leading to an increased modulation efficiency. Due to this increased efficiency, this SLM offers a solution with a reduced footprint for densely integrated RF-optical systems constrained by chip surface area, such as when RF modulators are used in an arrayed RF link application. Because a smaller MZM would potentially enable a simpler driving scheme, the SLM, in some embodiments, is placed in an unequal phase shifter architecture so that the heaters are omitted, relying on wavelength setting and/or adjusting the direct current (DC) bias voltages to set the modulator near its quadrature point. In some embodiments, the Si MZM has an architecture with tunable extinction ratio (ER), to quantify how ER impacts SFDR. Some embodiments are directed to an optimization method to obtain higher SFDR at a fixed operating slow-light wavelength by setting the junction bias condition and then adjusting the input and output splitting ratios.

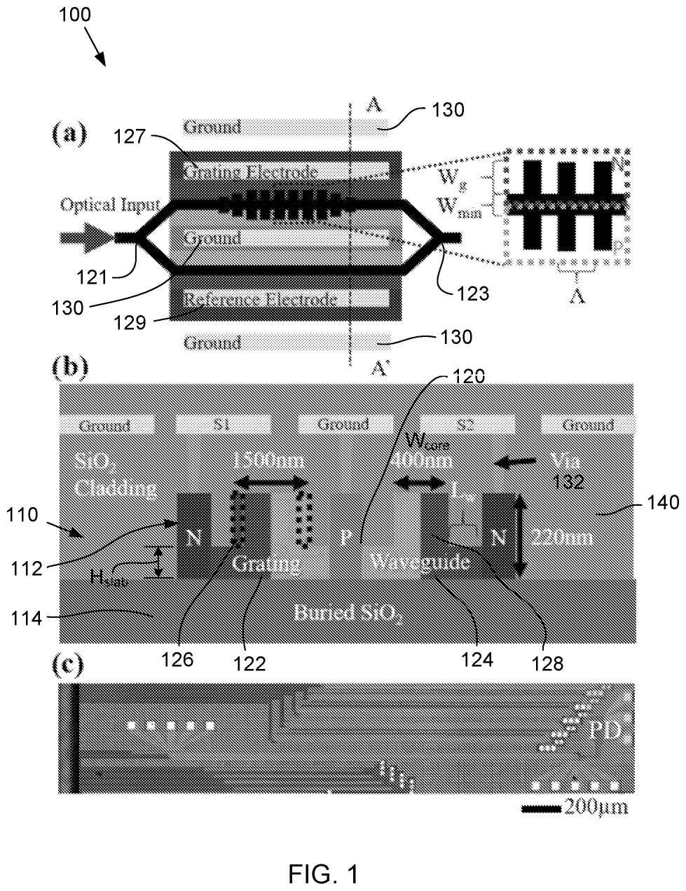

As shown in FIGS. 1A-1B, an SLM, also referred to herein as an MZM, is generally designated by the numeral 100. The SLM 100 includes a silicon-on-insulator (SOI) substrate 110 that includes a silicon device layer 112 on top of a silicon dioxide buried layer 114. In some embodiments, the device layer 112 is 220 nm thick and the buried layer 114 is 3 μm thick. A ridge waveguide 120 is formed from a partial etch of the device layer 112, creating a rib structure with core width W_{core} and slab height H_{slab}. The ridge waveguide 120 includes a grating arm 122 and a reference arm 124. A lateral junction is formed by doping the ridge waveguide 120 with p- and n-type dopants. The cross-section shown in FIG. 1B supports a forward propagating mode with velocity v=c/n_{eff} where n_{eff} is the effective index and is a function of the physical parameters W_{core} and H_{slab}, the material indices of the silicon core and silicon oxide cladding, and the dopant profile D(x,y). In some embodiments, a 2 mm long Bragg grating waveguide 126 is incorporated in the grating arm 122, and a straight waveguide 128 is incorporated in the reference arm 124. A grating electrode 127 is in the grating arm 122, a reference electrode 129 is in the reference arm, and a ground electrode 130 is centrally located in the ridge waveguide 120.

In some embodiments, the input optical signal is split into two paths by a y-splitter 121 and recombined afterward by a y-combiner 123, as shown in FIG. 1A. In some embodiments, the grating has a period Λ=282 nm, the center waveguide has a width of Wₘᵢₙ=400 nm to guide the optical field, and the grating bar width W_{g} follows a super-Gaussian apodization profile with a maximum W_{g} of 550 nm. The apodization serves to suppress the side band oscillations and reduce mode mismatch between the straight waveguide and the slow-light grating waveguide.

In some embodiments, the slab height H_{slab} is 110 nm, and it extends for a distance of L_{w}=3 μm to connect to the tungsten via 132. The P-N junction is formed in the center of the ridge waveguide 120, with moderate doping concentrations on the order of 1×10¹⁸ cm⁻³. A separation of 10 nm is set in the layout between the P and N regions. The travelling wave electrodes are terminated with a DC-block and a 50Ω resistor. In some embodiments, to improve signal isolation, two additional ground lines 130 are positioned surrounding the metal traces.

In some embodiments, the SLM 100 includes an unequal phase shifter architecture that is configured to set the modulator in quadrature without the use of external waveguide heaters. In some embodiments, the unequal phase shifter architecture includes a first electrical signal S1 applied to the grating electrode 127 while a second electrical signal S2 is applied to the reference electrode 129. The first electrical signal S1 includes a junction bias (e.g., a first DC bias) component and a small-signal RF component. The second electrical signal S2 includes only a second DC bias component. The biasing conditions on the grating electrode 127 and the reference electrode 129 are discussed in more detail below.

In some embodiments, a photodetector (PD) having a responsivity of 0.9 A/W (at λ=1550 nm) is in optical communication with the SLM 100 to convert the light to electrical signals. In some embodiments, both the SLM 100 and the PD 150 lie within a multi-project wafer (MPW) 140 and are interconnected by an embedded single-mode silicon photonic waveguide.

The linearity of a modulator informs which analog applications it may be suited for. In particular, the input third-order intercept point (IIP3) is often used as a specification of nonlinearity for RF-devices, while SFDR may be used to characterize the overall linear performance of an RF (or RF-Photonic) link. The output intensity of the SLM, lop, depends on the complex amplitude and phase imparted by each arm. The generalized transfer function of a MZI may be described as

$${I}_{op} = \frac{1}{4} {\vert {e}^{- {α}_{1} {L}_{1}} {e}^{- j {β}_{1} {L}_{1}} + {e}^{- {α}_{2} {L}_{2}} {e}^{- j {β}_{2} {L}_{2}} \vert}^{2} \qquad ( 1 )$$

where α is the loss per unit length, and β is the propagation constant, defined as

$$β = \frac{2 π {n}_{eff}}{λ}$$

and n_{eff} is the effective index. Subscripts “1” and “2” denote either arm of an MZM. Both α and β are functions of the operating wavelength. Unequal loss in the optical paths will result in deteriorated extinction ratio. For an ideal, lossless modulator with equal phase shifter length, Eq. (1) reduces to a squared cosine

$${lim}_{α \to 0} {I}_{op} \approx {cos}^{2} ( ( {β}_{2} - {β}_{1} ) L ) = {cos}^{2} ( φ + Δφ ) \qquad ( 2 )$$

where φ is the phase different between the two arms under DC conditions while Δφ is the additional phase variation caused by the input RF signal, \tilde{V}_{RF}. The MZM responds to the input \tilde{V}_{RF} most linearly when the DC phase component ϕ is selected such that the MZM operated near its quadrature. Theoretically, if Δφ(\tilde{V}_{RF}) could follow an inverse-cosine dependence for an ideal MZM, the composite transfer function is linear. For a practical MZM device, the nonlinear RF signal distortions come from multiple sources.

The square root dependence of depletion layer width on the driving voltage counts for a primary source of the signal distortion. Application of small signal \tilde{V}_{RF} varies with the depletion width, w, according to

$$( {\tilde{v}}_{RF} ) \approx \sqrt{\frac{2 {ε}_{Si}}{q} \frac{( {N}_{A} + {N}_{D} )}{( {N}_{A} {N}_{D} )} ( {V}_{bi} - {V}_{DC} - {\tilde{v}}_{RF} )} \qquad ( 3 )$$

where q is the electron charge, εₛᵢ is the permittivity of silicon, N_{A} (N_{D}) is the acceptor (donor) concentration, V_{bi} is the junction built-in voltage, and V_{DC} is the applied DC bias voltage across the junction. The carrier density modulation within the depletion layer ω(\tilde{V}_{RF}) leads to the change of the refractive index, Δn and the absorption coefficient Δα following a linear relation:

$$Δ n ∝ - ( \frac{Δ {N}_{e , h}}{\sqrt{{ε}_{S i}}} ) and Δα ∝ ( \frac{Δ {N}_{e , h}}{\sqrt{{ε}_{Si}}} ) \qquad ( 4 )$$

where ΔN_{e,h} is the change in electron or hole concentration. The effective index of the Si waveguide also follows a nonlinear relation with the weighted spatial integral of the optical mode with the free carrier plasma density. The varying group index due to apodization near the photonic band edge of the grating is another source of nonlinearity. Kerr effect of Si material induces additional nonlinear optical distortion. The measured RF link linearity combines all sources of signal distortion, where each source of nonlinearity may contribute to, or partially cancel, the total distortion.

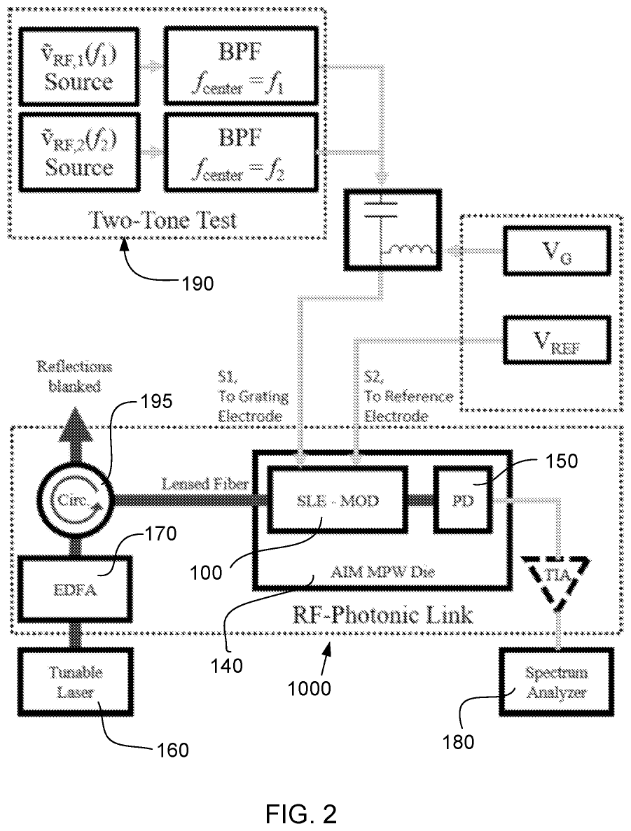

In an exemplary embodiment, a two-tone test was utilized to character the nonlinearity and SFDR of the SLM 100. The experimental setup is depicted in FIG. 2. An RF-photonic link 1000 includes the SLM 100 and the PD 150 in the MPW 140. The MPW 140 is mounted on an external thermoelectric cooler at a fixed temperature of 20° C. A polarization-maintaining lensed fiber injects light onto the die from a wavelength tunable laser 160. An Erbium-doped fiber amplifier (EDFA) 170 was connected after the laser to produce an optical power up to 20 dBm. The fiber to chip coupling loss is estimated to be 2 dB/facet. At the output of the RF-photonic link 1000, the PD output is optionally amplified by an external low-noise amplifier and is collected by an RF spectrum analyzer 180. Under testing, DC biases are applied to the grating arm and the reference arm, denoted as V_{G} and V_{REF}, respectively.

In some embodiments, a dual-channel microwave generator 190 supplies the RF signals at frequencies f₁=500 MHz and f₂=515 MHz with equal amplitude. These tones, combined with the grating arm DC bias V_{G} by a bias-tee, are applied to the grating electrode. The DC bias voltage V_{REF} varies to obtain different MZM operation condition. Band-pass filters (BPF) tuned to the center frequency of each source to provide signal isolation as well as rejecting reflected RF signals by >40 dB. Separately, an optical circulator 195 is used to prevent feedback from the chip reflecting into the input laser source and EDFA.

The SLM 100 and other components in the RF link 1000 will cause spurious power at harmonics of the input frequencies as well as intermodulation products: f₁±f₂, f₁±2f₂, 2f₁±f₂, etc. In a typical application where the input tones are closely spaced, the third-order intermodulation distortion products (IMD3) are within the same band as the input tones, making them difficult to filter, so IMD3 suppression is a primary objective in some embodiments of the present technology. The equal input tone powers are systematically increased, and the fundamental power and IMD3 power are monitored at the spectrum analyzer to seek an operating point of the SLM that minimizes the IMD3 spur of the RF link.

In an exemplary RF link, the modulator, the Si waveguide, the on-chip SiGe PD and the external amplifier all contribute to the RF signal distortion. SFDR is a measure of link linearity, and the modulator performance must be analyzed in the context of the entire RF link. The best-case insertion loss of the modulator and photodetector on-chip is 13.5 dB, which includes approximately 2 dB loss from the lensed-fiber/chip interface. Low-noise trans-impedance amplifiers (TIAs) are typically included in two-tone measurement. In some embodiments, the TIA is omitted since the PD output power is sufficiently high. The measurements are limited by the noise floor of the spectrum analyzer at −110 dBm with 10 kHz bandwidth.

Some embodiments first characterized the transmission spectrum of a slow-light grating waveguide fabricated on the same die as the SLM 100. Using a tunable laser (λ=1460 nm to 1580 nm), two photonic bandgaps were observed. In some embodiments, the apodization is designed to suppress the side bands of the right side of the lowest order band edge, so the SLM testing focuses on the wavelength range of 1545-1555 nm.

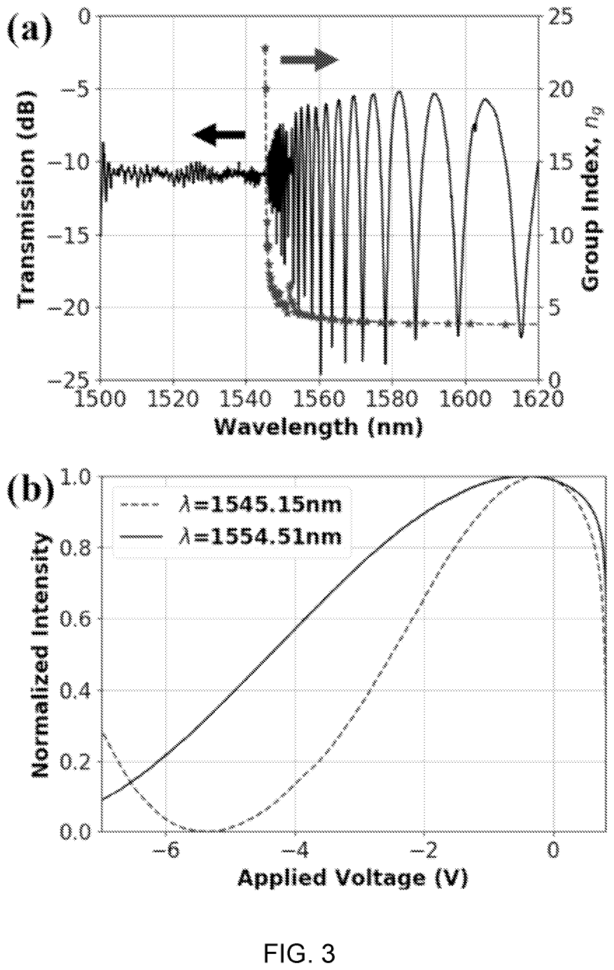

The transmission spectra of the SLM 100 output are depicted in FIG. 3A. The slow-light effect can be seen by the narrowing of the free spectrum range (FSR) in the SLM transmission when approaching the band-edge. The group index (n_{g}) of the Bragg grating waveguide was characterized using an interferometric method. The measured n_{g} decreases monotonically from the band edge at λ=1545 nm to ˜1548 nm from a maximum n_{g}=11 to 4.5. At λ=1550 nm, the slow light effect is much weaker and can be considered negligible. The modulation efficiency of the SLM was tested at λ=1545.15 nm and λ=1554.51 nm for comparison, as shown in FIG. 3B. At the reverse bias-5.33 V, the SLM reaches its minimum output at λ=1545.15 nm while the SLM needs to bias at a much higher voltage to the avalanche breakdown region to reach its minimum when λ=1554.51 nm. The tested figure-of-merit V_{π}·L is ˜1 V·cm in the slow-light regime under depletion operation.

In some embodiments, the intrinsic bandwidth of depletion type Si modulators is 50 GHz. However, both the traveling wave electrode design and the driving circuit impact the RF bandwidth of the modulator. Additionally, the insertion loss of the modulator will also indirectly impact the bandwidth as a lossy optical link results in reduced sensitivity in the PD. For an RF link, the loss figure or link gain can be evaluated from the slope efficiency, as discussed in more detail below.

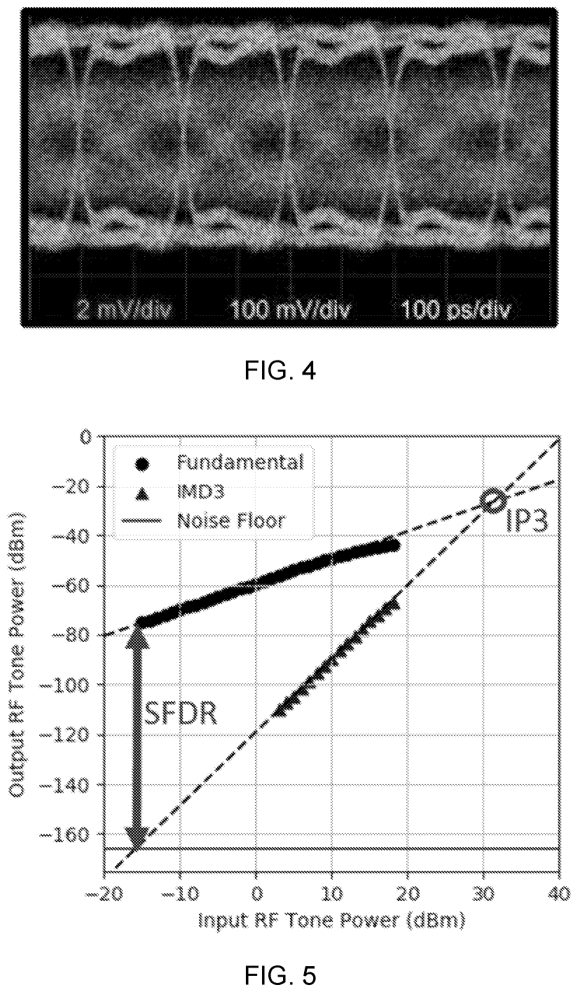

In some embodiments, the eye diagram performance of the SLM 100 was measured. Measurements were performed with an input laser at a λ=1550 nm. There is a tradeoff between stronger slow-light and the resulting output power. A sufficiently high output power is required to make a decent eye-diagram. The modulation signal is a 7-bit pseudo-random bit sequence (PRBS7), applied to the SLM 100 using an arbitrary waveform generator (AWG). The SLM 100 works up to a speed of 8 Gbps and an example measurement taken at a speed of 5 Gbps is shown in FIG. 4.

In some embodiments, the link SFDR is sensitive to a wide range of parameters of the SLM, including the selected operating wavelength and DC bias voltages on the phase shifter and the reference arm. A representative plot of SFDR computation is provided in FIG. 5, representing the dynamic range of the fundamental tone before the IMD3 tone “spur” is greater than the noise floor. The SFDR is reported with reference to a 1 Hz bandwidth. For V_{G}=V_{REF}=−3V at a slow-light wavelength 1545.15 nm, the SFDR is 90.86 dB/Hz^{2/3}. The IIP3 occurs at +31.4 dBm, and the 1 dB compression point occurs at +12.5 dBm. Subsequent measurements of SFDR herein were measured from a single input tone power below the 1 dB compression point.

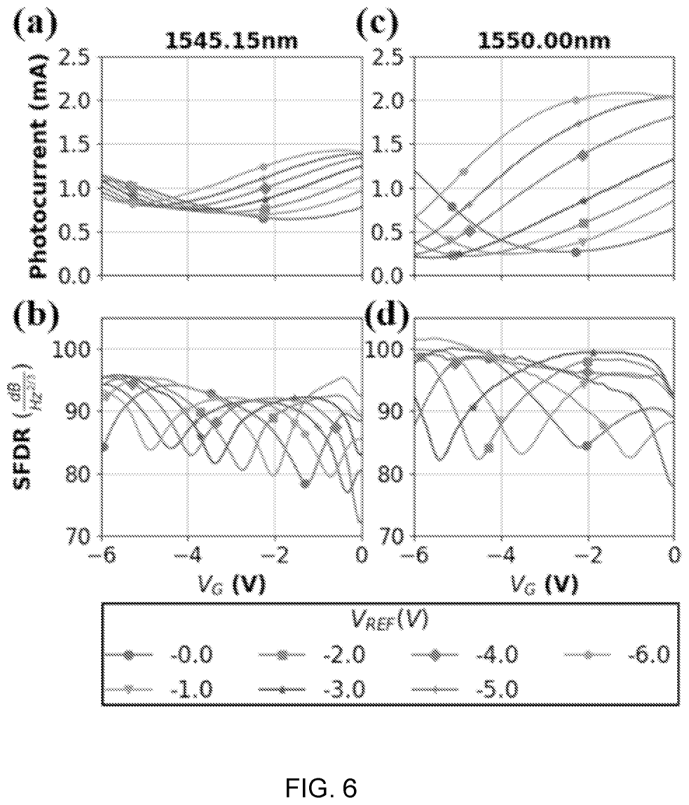

In some embodiments, next, the bias voltages V_{G} and V_{REF} are swept at selected wavelengths, to determine the optimal biasing point for linear operation. At a fixed V_{REF} and a slow-light condition, the quadrature point of the SLM is set by varying V_{G}, as shown in FIG. 6. For example, with V_{G} fixed at −3 V and λ=1545.15 nm, a maximum SFDR is obtained when V_{REF}=−6 V. When V_{G} is varied to −5.5 V and V_{REF}=−3 V, a higher SFDR=96 dB/Hz^{2/3} was obtained. The maximum achievable SFDR follows an envelope which is greatest at larger depletion biases V_{G}. Optical field scattering loss increases with stronger slow-light effect, resulting in reduced extinction ratio of the SLM in the slow-light region. This additional loss factor contributes to a decrease in SFDR of a SLM at 1545.15 nm.

The slope efficiency sₘ of a modulator is an important figure-of-merit which is defined as the derivative of the transfer function (T) at the bias point. For a MZM, it can be expressed as

$${s}_{m} = {RP}_{L} \frac{\partial T ( {\tilde{v}}_{m} )}{\partial {\tilde{v}}_{m}} {\vert}_{{V}_{DC}} \approx - \frac{π {T}_{max} {RP}_{L}}{2 {V}_{π}} \qquad ( 5 )$$

where R is the modulator impedance and P_{L} is optical input power. The subscript m is used to denote which phase shifter the small signal \tilde{v}ₘ will be applied to. Tₘₐₓ is the peak of the SLM transfer function, corresponding to the maximum output power of the SLM that decrease near the band-edge due to increased scattering loss. The right-hand side of Eq. (5) gives an approximation of sₘ for an ideal sinusoidal transfer function, indicating that sₘ is generally proportional to Tₘₐₓ and inversely proportional to V_{π}. Therefore, one approach to increase sₘ is to decrease V_{π}, generally by increasing the length L of the phase shifter arm. An increased L gives larger junction capacitance Cₘ, which in turn limits the bandwidth f_{BW} of the modulator:

$${f}_{B W} ∝ \frac{1}{{C}_{m}} \qquad ( 6 )$$

The link gain G is proportional to the square of slope efficiency. Besides higher bandwidth, a smaller V_{π} is also in favor of a better link gain:

$$G ∝ {s}_{m}^{2} ∝ \frac{1}{{V}_{π}^{2}} \qquad ( 7 )$$

The SLM has an increased modulation efficiency, V_{π}·L=˜1 V·cm due to enhanced optical field and plasma interaction, so a reduced V_{π} of the SLM will also give rise to higher RF linear modulator slope efficiency. A slope efficiency enhancement (SEE) factor can be quantitatively evaluated by applying \tilde{V}_{RF} to the grating arm in comparison with applying \tilde{V}_{RF} to the reference arm under the same bias point and operating wavelength. The SEE is then defined as the relative change in slope efficiency expressed as a percentage:

$$SEE = \frac{\vert {s}_{G} \vert - \vert {s}_{REF} \vert}{\vert {s}_{REF} \vert} \times 100 \% \qquad ( 8 )$$

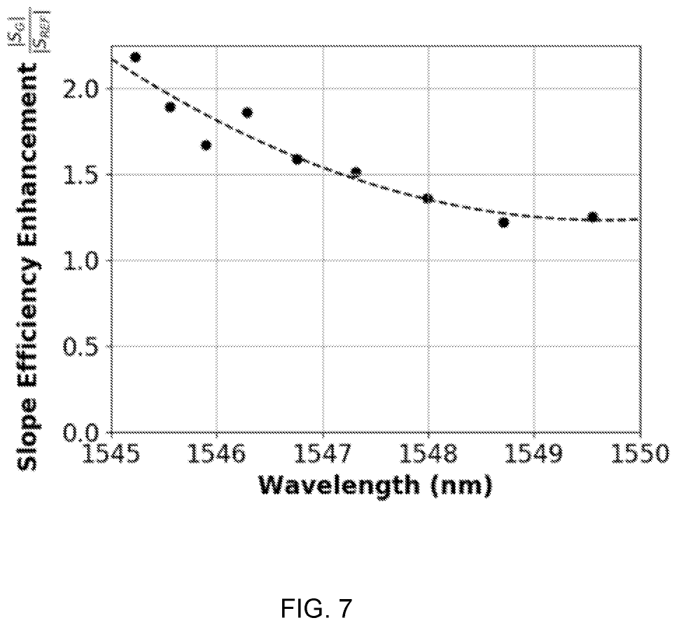

The measured SEE factor at selected quadrature points is depicted in FIG. 7, when V_{G}=V_{REF}=−3 V. When operating near the band edge, the slow-light grating phase shifter demonstrate a SEE of 2.18 at λ=1545.15 nm and SEE decreases monotonically with wavelength as the slow-light effect weakens. Overall, the slow-light grating phase shifter displayed the slow light effect in a range up to 4 nm from the band-edge. A residual SEE=˜1.2 at λ=1550 nm was observed, which could be caused by slight fabrication offsets of the junctions in each respective arm. The SLM demonstrates a solution to reduce V_{π} without augmenting the phase shifter length which would otherwise increase the junction capacitance.

In some embodiments, although a Bragg grating is a dispersive optical element, the modulated RF signals are not further distorted by this dispersion, as they propagate through the grating phase shifter as a purely phase-modulated signal at the optical carrier frequency. It is only at the combiner of the MZI that the phase modulation leads to amplitude modulation, and the RF signals appear as optical sidebands which will propagate through the remainder of the RF link with unequal dispersion.

Accordingly, embodiments of the present technology are directed to a slow-light enhanced scheme for an integrated photonic silicon modulator. The IMD3 of the RF signals and the SFDR were characterized through a two-tone test method. The Si Mach-Zehnder modulator architecture is designed to have unequal arms to operate on a simplified driving scheme. As a result, on-chip thermal heaters are omitted, and the modulator can configure near its quadrature point by adjusting the wavelength to the modulator. Owing to enhanced light-matter interaction in the slow-light region, an increased slope efficiency is observed in the modulator. By selecting the optimal DC bias to the grating and the reference arms of the modulator, an SFDR of 96 dB/Hz^{2/3} can be obtained in the RF link at the slow-light region. The slow-light modulator also displays increased modulation efficiency allowing for a reduced footprint for large array integration. In contrast to typical dual-drive methods and conventional single-drive schemes, the DC bias across the reference arm and the operating wavelength can be controlled to maximize the small-signal linearity. Simultaneously, this control of the biases removes the need for external waveguide heaters to set the SLM 100 at its quadrature point, giving rise to small device/system footprint and a simplified operation scheme. An enhanced modulation efficiency V_{π}·L_{π}=˜1 V·cm and a reduced V_{π} is demonstrated in the slow-light region compared to those operating far from the grating band-edge. In the slow-light region, under moderate to large depletion conditions, the SLM 100 was tested to have a SFDR of 96 dB/Hz^{2/3}. The present technology demonstrates the feasibility of a chip-scale RF link that consists of a SLM and integrated SiGe photodetector for RF photonic applications.

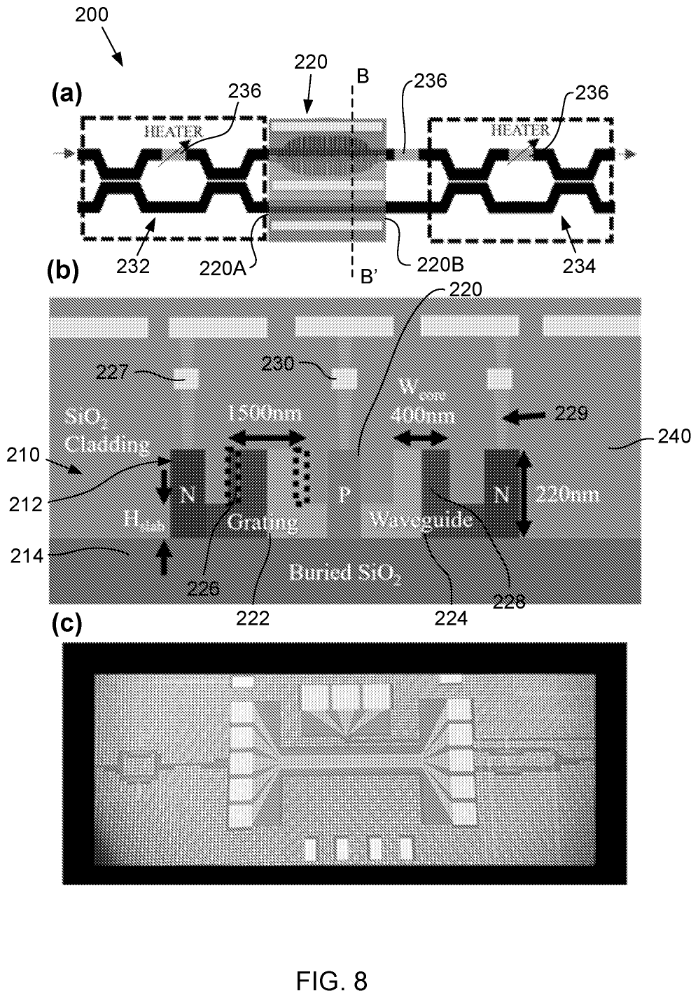

As shown in FIGS. 8A-8B, an SLM, also referred to herein as a Mach-Zehnder interferometer (MZI), is generally designated by the numeral 200. The SLM 200 includes a silicon-on-insulator (SOI) substrate 210 that includes a silicon device layer 212 on top of a silicon dioxide buried layer 214. In some embodiments, the device layer 212 is 220 nm thick and the buried layer 214 is 3 μm thick. A ridge waveguide 220 is formed from a partial etch of the device layer 212, creating a rib structure with core width W_{core} and slab height H_{slab}. The ridge waveguide 220 includes a grating arm 222 and a reference arm 224. A lateral junction is formed by doping the ridge waveguide 220 with p- and n-type dopants. The cross-section shown in FIG. 8B supports a forward propagating mode with velocity v=c/n_{eff} where n_{eff} is the effective index and is a function of the physical parameters W_{core} and H_{slab}, the material indices of the silicon core and silicon oxide cladding, and the dopant profile D(x,y). In some embodiments, a grating waveguide 226 is incorporated in the grating arm 222, and a straight waveguide 228 is incorporated in the reference arm 224. A grating electrode 227 is in the grating arm 222, a reference electrode 229 is in the reference arm, and a ground electrode 230 is centrally located in the ridge waveguide 120. In some embodiments, the ridge waveguide 220 is formed within an MPW 240.

In some embodiments, a first thermo-optic switch (TOS) 232 is in optical communication with an input side of the ridge waveguide 220A and a second TOS 234 is in optical communication with an output side of the ridge waveguide 220B, as shown in FIG. 8A. The first TOS 232 and the second TOS 234 each include a heater 236. The first TOS 232 and the second TOS 234 are configured to adjust a splitting ratio of an input optical signal inputted to the input side of the ridge waveguide 220A and an output optical signal outputted from the output side of the ridge waveguide 220B. The first TOS 232 and the second TOS 234 allow for a voltage-controlled, continuously variable output splitting ratio into the two MZI paths (the grating arm 222 and the reference arm 224) and offers the possibility to pre-compensate for the excess loss of the grating arm 222, which will improve the achievable extinction ratio. In some embodiments, another heater 236 is positioned in-line with the grating arm 222 between the output side of the ridge waveguide 220B and the second TOS 234, this heater 236 is configured to set the SLM 200 in quadrature.

In some embodiments, as the junction is modulated with a time-varying voltage \tilde{V}(t), the n_{eff} of the cross-section will then vary nonlinearly with applied voltage. The field propagating in this cross-section for a length of L will acquire a phase shift of φ=βL=2πn_{eff}/λ L (radians) and will be attenuated due to material and dopant losses, by an effective attenuation constant α (dB/m). Both α and β are sensitive to the doping profile and are nonlinear functions of the applied voltage at each wavelength λ.

As shown in Table 1 below, two distinct geometries of slow-light phase shifter, labelled respectively Sample ID A or B, were fabricated. For each, the minimum width of the grating is 400 nm. The SLM 200 which is only 150 μm long may be treated as a lumped element electrode. Each grating is also apodized with a super-Gaussian profile, which is dependent on the grating's total length. This smaller SLM 200 has approximately one order of magnitude stronger doping concentration in the P region. Rather than a P-N junction, it is PP-N, to increase the modulation efficiency as would be needed in such a small length device.

TABLE 1
Device Parameters

| Sample | Length | Grating Max. | Doping |
|---|---|---|---|
| ID | (μm) | Width (μm) | Level |
| A | 500 | 800 | N, P |
| B | 150 | 800 | N, PP |

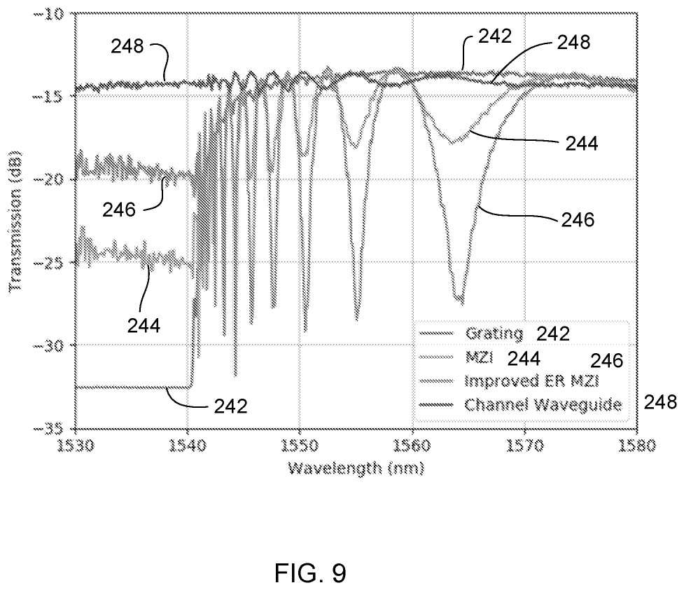

The reconfigurability of the SLM 200 is shown in FIG. 9. As shown, the transmission through the SLM 200 can output the grating transfer function alone (0V) 242, an MZI transfer function (2.0V) 244, the ER optimized MZI transfer function (2.5V) 246, and the channel waveguide all-pass device (3.75V) 248. In the limiting cases where the TOS 232, 234 are operated as true-switches, 100% of the light passes through only one arm of the SLM 200, and no interference results. Instead, the device transmission is identical to that of the grating phase shifter alone. In this mode, it may be used as a phase modulator, instead of an intensity modulator. At the opposite switching condition, the device drops out of the optical path entirely, producing the transfer function of the all-pass silicon waveguide alone. At intermediate voltages, the switch continuously tunes through power-splitting fractions which produce the characteristic MZI interference.

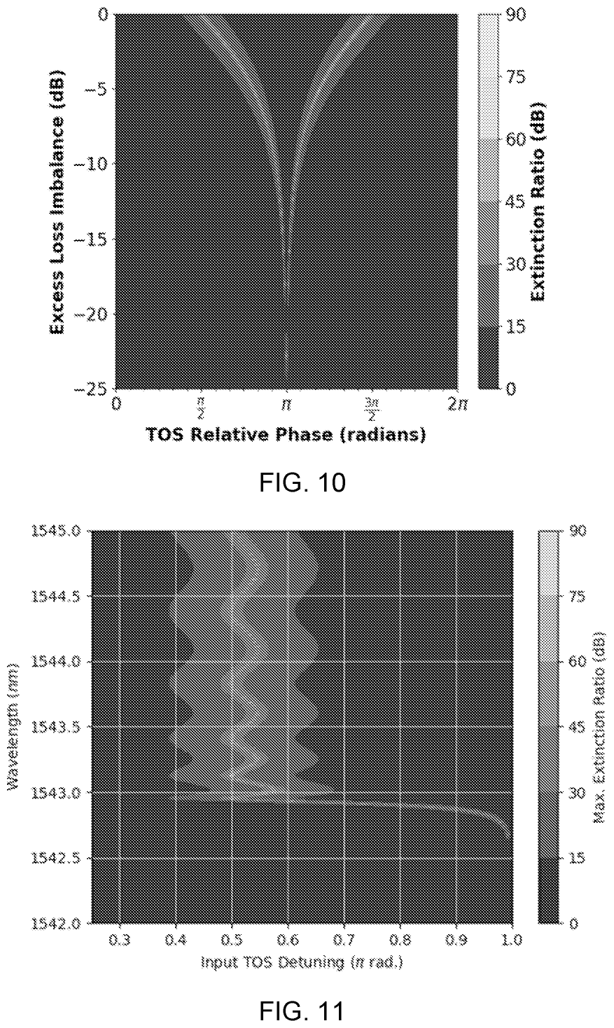

In some embodiments, at a splitting ratio where the excess loss of the grating is exactly compensated by the unequal loss into the two MZI arms, the MZI extinction ratio is optimized, at the wavelength of operation. As the grating phase shifter approaches the band-edge, the transmission through the grating is reduced by an excess loss factor compared to the reference rib waveguide. The optimal relative splitting phase of the control section of an ideal TOS is shown in FIG. 10. In some embodiments, for SLM 200, the optimal extinction ratio is a sensitive function of the input TOS phase and the wavelength-dependent excess loss, as shown in FIG. 11.

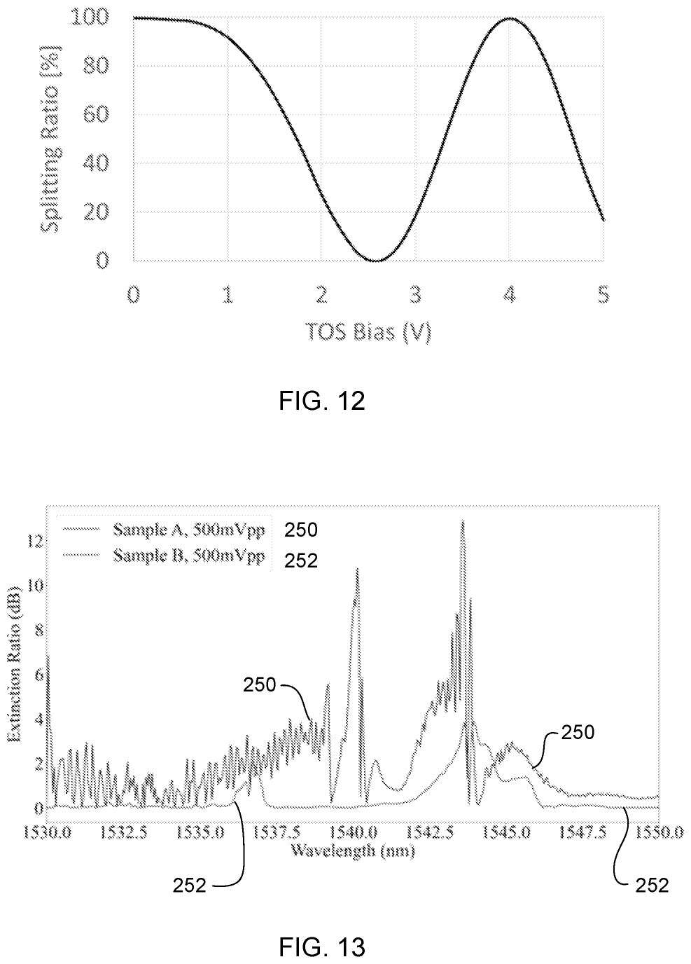

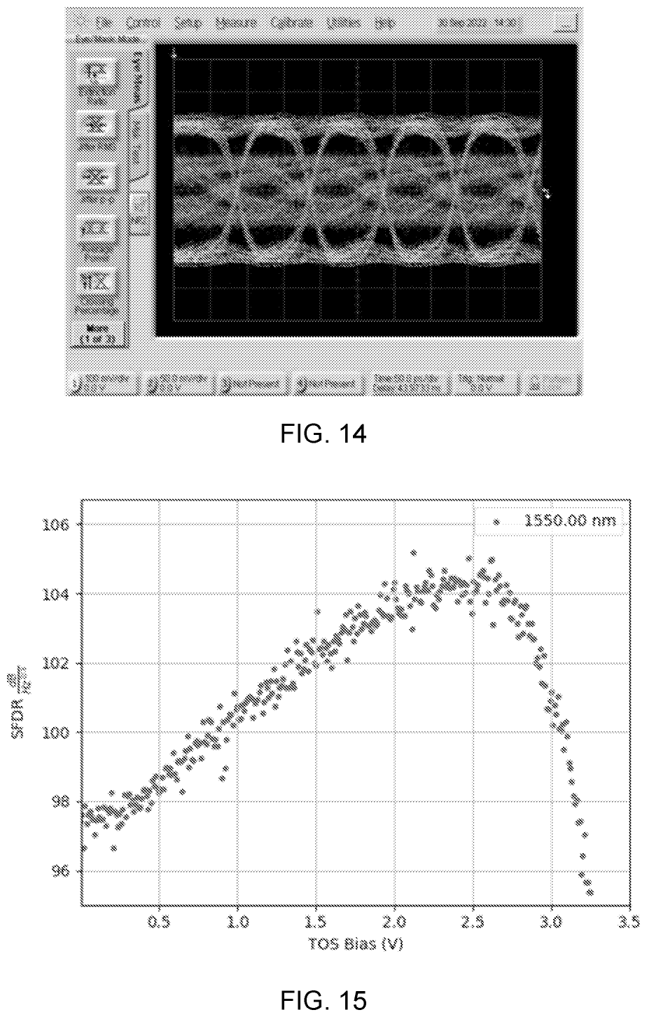

In an exemplary embodiment, like the methodology for a two-tone measurement of a single-arm driven SLM 100 as disclosed above, the chip of SLM 200 was affixed to an alumina-oxide interposer with copper traces using a thermally conductive, electrically insulating epoxy, the DC connections (the TOS electrical contacts, and the quadrature-setting phase shifter electrodes) were wire-bonded to the interposer with 0.7 mil gold wire, and an air-coplanar probe with ground-signal-ground-signal-ground contacts (GSGSG) were used to apply the junction bias and any RF signals to the PN junction across each MZI arm. The measured power-splitting behavior of a single TOS is shown in FIG. 12. The output TOS is fixed at a 50% splitting ratio, so that it acts like a y-branch recombiner. In some embodiments, the single-ended drive on both SLMs 200 and a differential drive were tested, and dual-arm push-pull configuration on the better performing SLM 200 was tested. The single-ended drive configuration is the same configuration discussed above regarding SLM 100. The wavelength was chosen by evaluating where the static ER is highest. The differential drive signal configuration is different due to both arms being applied complementary PRBS7 signals. For the eye diagram testing, no bias was applied to the TOS on sample A, leading to a 50-50 split.

The total phase difference between the arms of the SLM 200 varies strongly as a function of wavelength, and so the additional phase required to be supplied by the thermo-optic heater 236 to operate at the quadrature point will also vary strongly versus wavelength. By monitoring the output RF signal as the heater bias sweeps through 2π phase, the properties of a small signal applied at every point along the MZI transfer function, including at the quadrature point, is evaluated.

In some embodiments, the thermo-optic heaters 236 were not used during eye diagram testing, meaning that the wavelength of operation must be carefully chosen for the SLM 200 to be in quadrature and to ultimately produce an eye diagram. FIG. 13 plots the static extinction ratio across different wavelengths for Sample A (indicated by reference numeral 250) and Sample B (indicated by reference numeral 252). Higher extinction ratios generally lead to better performing eye diagrams. The static ER plot shifts slightly compared to the dynamic ER equivalent that would result from the eye diagram testing, however the static ER plot is still useful as a reference. The single drive configuration eye diagrams led to operational speeds up to 5 Gbps and 8 Gbps for Sample A and B, respectively. Although the ER is worse for Sample B, it is still able to achieve higher operational speeds, likely due to having a higher output signal. The higher output signal is a result of the reduced length in Sample B, causing it to be a lower loss device, despite having stronger doping levels than Sample A.

In some embodiments, the differential drive, dual-arm push-pull configuration was tested with Sample B. This configuration allowed Sample B to attain operational speeds up to 15 Gbps. An example at 10 Gbps is shown in FIG. Error! Reference source not found.14. The optimal wavelength used was 1540.4 nm, indicating a shift of ˜3 nm from the wavelength suggested by FIG. 13, a DC bias of −6V was used. The SFDR is measured as a function of the input TOS bias voltage. By optimizing the bias, the SFDR is improved to a maximum of 105 dB/Hz^{2/3}, as shown in FIG. 15.

Accordingly, embodiments of the present technology are directed to the design, fabrication, and characterization of slow-light enhanced Si optical modulators that are manufactured using multi-wafer project. Two exemplary designs were evaluated and tested for both digital and analog applications. A ID Bragg grating structure was used to produce a slow-light effect. The first design is an MZM that has a phase shifter length of 500 μm. A thermal splitter is incorporated so that an uneven splitting takes place between those two arms to maximize the ER. The modulator bandwidth and SFDR as a function of ER are reported. An SFDR of 106 dB/Hz^{2/3} at the slow light regime was obtained. The second design is a MZM that has phase shifter length of 150 μm. A V_{π} of 6.6 V was obtained with a modulation efficiency of 0.1 V·cm. An eye diagram of 15 Gbps was tested and an SFDR of 99 dB/Hz^{2/3} was obtained. The slow-light effect increases the light-matter interaction within the SLM 200 while reducing the available extinction ratio due to an excess loss imbalance in the grating and reference arms 222, 224. Adjusting the power splitting ratio into the SLM 200 allows for an optimization of the extinction ratio of the modulator. Separately, the tunable splitting ratio may be used to optimize the SFDR.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A slow-light photonic modulator comprising:
a silicon-on-insulator substrate comprising a silicon device layer on top of a silicon dioxide buried layer;
a ridge waveguide formed by partially etching the silicon device layer, the ridge waveguide comprising a grating arm and a reference arm;
a grating waveguide in the grating arm;
a grating electrode in the grating arm;
a straight waveguide in the reference arm;
a reference electrode in the reference arm; and
a lateral junction formed by doping the ridge waveguide with p-type and n-type dopants.

2. The slow-light photonic modulator of claim 1, further comprising:
a y-splitter configured to split an input optical signal into two paths, a first of the two paths passes through the grating arm and a second of the two paths passes through the reference arm; and
a y-combiner configured to recombine the first and the second of the two paths into an output optical signal after the first and the second of the two paths passes through the respective grating and reference arms.

3. The slow-light photonic modulator of claim 2, further comprising an unequal phase shifter architecture configured to set the modulator in quadrature without the use of external waveguide heaters.

4. The slow-light photonic modulator of claim 3, wherein the unequal phase shifter architecture comprises:
a first electrical signal applied to the grating electrode, the first electrical signal comprising a first direct current bias component and a small-signal radio-frequency component; and
a second electrical signal applied to the reference electrode, the second electrical signal comprising a second direct current bias component.

5. The slow-light photonic modulator of claim 4, wherein the small-signal radio-frequency component comprises a first radio-frequency signal and a second radio-frequency signal, each of which passes through respective first and second band-pass filters before being combined with the first direct current bias component.

6. The slow-light photonic modulator of claim 5, wherein the first radio-frequency signal and the second radio-frequency signal are supplied by a dual-channel microwave generator.

7. The slow-light photonic modulator of claim 4, wherein the first direct current bias component comprises a direct current bias voltage, and the second direct current bias component comprises a variable direct current voltage.

8. The slow-light photonic modulator of claim 7, wherein the first direct current bias component and the second direct current bias component are supplied by a bias-tee.

9. The slow-light photonic modulator of claim 1, further comprising a silicon-germanium photodetector in optical communication with the ridge waveguide.

10. The slow-light photonic modulator of claim 9, wherein the silicon-germanium photodetector is positioned in the silicon-on-insulator substrate and is in optical communication with the ridge waveguide via an embedded single-mode silicon photonic waveguide.

11. The slow-light photonic modulator of claim 1, further comprising:
a first thermo-optic switch in optical communication with an input side of the ridge waveguide, the first thermo-optic switch comprising a first heater; and
a second thermo-optic switch in optical communication with an output side of the ridge waveguide, the second thermo-optic switch comprising a second heater;
the first thermo-optic switch and the second thermo-optic switch configured to adjust a splitting ratio of an input optical signal inputted to the input side of the ridge waveguide and an output optical signal outputted from the output side of the ridge waveguide.

12. The slow-light photonic modulator of claim 11, further comprising a third heater positioned in-line with the grating arm between the output side of the ridge waveguide and the second thermo-optic switch, the third heater configured to set the modulator in quadrature.

13. The slow-light photonic modulator of claim 12, wherein the lateral junction comprises a P region and an N region, the P region has a doping concentration that is one order of magnitude greater than a doping concentration of the N region such that the lateral junction is a PP-N junction.

14. The slow-light photonic modulator of claim 13, wherein the ridge waveguide has a length of 500 μm or less.

15. The slow-light photonic modulator of claim 14, wherein the ridge waveguide has a length of 150 μm.

16. A radio-frequency photonic link comprising:
a slow-light photonic modulator according to any of the preceding claims;
a tunable laser configured to provide an input optical signal to the slow-light photonic modulator;
an optical circulator positioned between the tunable laser and the slow-light photonic modulator;
an erbium-doped fiber amplified positioned between the tunable laser and the optical circulator; and
a radio-frequency spectrum analyzer configured to receive an output optical signal from the slow-light photonic modulator.

17. The radio-frequency photonic link of claim 16, further comprising an external low-noise amplifier positioned between the slow-light photonic modulator and the radio-frequency spectrum analyzer.
